(19) United States
(12) Patent Application Publication
(10) Pub. No.: US 2020/0372547 A1
(43) Pub. Date: Nov. 26, 2020

(54) USING DIGITAL LEDGER TECHNOLOGY TO TRACK TRANSACTIONS OF A CONTACT CENTER FOR VOICE AND/OR VIDEO COMMUNICATIONS THAT ARE ON HOLD IN A CONTACT CENTER QUEUE

(71) Applicant: Avaya Inc., Santa Clara, CA (US)

(72) Inventors: Pushkar Yashavant Deole, Pune (IN); John Young, Buntingford (GB)

(21) Appl. No.: 16/420,404

(22) Filed: May 23, 2019

(51) Int. Cl. G06Q 30/02; H04L 29/06; H04L 29/08

(52) U.S. Cl. CPC G06Q 30/0275; H04L 65/1069; G06F 3/167; H04L 67/306; H04L 65/601

(57) ABSTRACT

An offer is sent, via a network, to an entity system. For example, the entity system may be a computer system of a corporation. The offer is to provide advertising while one or more voice or video communication sessions are placed on hold in a contact center queue. An acceptance of the offer is received, via the network, from the entity system. The acceptance of the offer causes a blockchain orchestrator to create a block that is stored in a blockchain. A voice or video communication session is established at the contact center with a customer. The voice or video communication session is routed to a contact center queue. In response to routing the voice or video communication session to the contact center queue and based on the acceptance of the offer, the advertising is inserted into a media stream of the voice or video communication session.

### FIELD

The disclosure relates generally to contact centers and particularly to transaction management in a contact center.

### BACKGROUND

When customers call into a contact center, the customers typically answer questions by interacting with Interactive Voice Response (IVR) systems. Based on how the customers respond, the customers then get placed on hold in one or more contact center queues while waiting for contact center agents to become available and service the customers. While waiting in the contact center queue(s), the customers typically hear some type of music on hold. When the customers are placed on hold, there is a lost opportunity to provide additional services to the customer.

### SUMMARY

These and other needs are addressed by the various embodiments and configurations of the present disclosure. An offer is sent, via a network, to an entity system. For example, the entity system may be a computer system of an enterprise. The offer is to provide advertising for products of the enterprise for a certain amount of time while one or more sessions of a particular profile of customers are placed on hold in a contact center queue. An acceptance of the offer is received, via the network, from the entity system. The acceptance of the offer causes a blockchain orchestrator to create a block that is stored in a blockchain and causes the exchange of digital tokens. A voice or video communication session is established at the contact center with a customer. The voice or video communication session is routed to a contact center queue. In response to routing the voice or video communication session to the contact center queue and based on the acceptance of the offer, the advertising is inserted into a media stream of the voice or video communication session (e.g., via an Interactive Voice Response (IVR) system).

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “blockchain” as described herein and in the claims refers to a growing list of records, called blocks, which are linked using cryptography. The blockchain is commonly a decentralized, distributed and public digital ledger that is used to record transactions across many computers so that the record cannot be altered retroactively without the alteration of all subsequent blocks and the consensus of the network. Each block contains a cryptographic hash of the previous block, a timestamp, and transaction data (generally represented as a merkle tree root hash). For use as a distributed ledger, a blockchain is typically managed by a peer-to-peer network collectively adhering to a protocol for inter-node communication and validating new blocks. Once recorded, the data in any given block cannot be altered retroactively without alteration of all subsequent blocks, which requires consensus of the network majority. In verifying or validating a block in the blockchain, a hashcash (or other algorithm) algorithm generally requires the following parameters: a service string, a nonce, and a counter. The service string can be encoded in the block header data structure, and include a version field, the hash of the previous block, the root hash of the merkle tree of all transactions (or information or data) in the block, the current time, and the difficulty level. The nonce can be stored in an extraNonce field, which is stored as the left most leaf node in the merkle tree. The counter parameter is often small at 32-bits so each time it wraps the extraNonce field must be incremented (or otherwise changed) to avoid repeating work. When validating or verifying a block, the hashcash algorithm repeatedly hashes the block header while incrementing the counter & extraNonce fields. Incrementing the extraNonce field entails recomputing the merkle tree, as the transaction or other information is the left most leaf node. The body of the block contains the transactions or other information. These are hashed only indirectly through the Merkle root.

The term “digital token” as referred herein and in the claims is a form of digital currency (i.e., a virtual currency) that is used by a contact center. A digital token may refer to existing digital currencies, such as Bitcoin. The digital token is implemented by using a custom Digital Ledger Technology (DLT)/Blockchain orchestrator. A blockchain orchestrator is deployed to programmatically exchange digital tokens from one counterparty to the other once an agreement has been finalized. The types of programming languages used to implement blockchain orchestrators include Solidity (Ethereum) and Go (Hyperledger Fabric). The digital token leverages some of the concepts that are associated with the proposed Non-Fungible Ethereum Token standard (i.e. ERC 721). Two potential methods can be used to access the digital token meta-data. The meta-data can either be included in parametric form as part of the digital token blockchain orchestrator, or as a vector that can securely reference the meta-data off-chain within a separate data repository. Since it can be more expensive to share meta-data in parametric form and is arguably less secure, the use of a vector reference is recommended. Digital token meta-data may be based on UUID—RFC 4122).

As described herein and in the claims, the term “blockchain orchestrator” can be or may include any software module that can manage a blockchain, such as, a smart contract, a blockchain manager, and/or the like.

As described herein and in the claims, the term “contact center queue” may be any computer construct where a voice or video communication session is placed on hold. For example, the contact center queue may be a first-in-first out contact center queue, a contact center pool (i.e., where agents select a voice or video call from the contact center pool), and/or the like.

As described herein and in the claims, when referring to digital tokens, a number of digital tokens may include any number of digital tokens from zero to N, where N is an integer (either positive or negative).

As described herein and in the claims, the term “entity” can be or may include any type of entity, such as, an organization, an enterprise, a corporation, a business, a partnership, an individual person, and/or the like.

As described herein and in the claims, the term “advertising” can mean any type of marketing campaign for a particular product(s) of a business entity.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for inserting advertising into a voice and/or video stream of a communication session while the communication session is placed on hold.

FIG. 2 is a flow diagram of a process for negotiating an offer and using a blockchain to track an acceptance of the offer.

FIG. 3 is a flow diagram of a process for inserting advertising into a voice and/or video stream of a communication session according to terms of an offer while the communication session is placed on hold in a contact center queue.

FIG. 4 is a flow diagram of a process for managing a bidding process in a contact center.

FIG. 5 is a flow diagram of a process for registering entities with the contact center.

### DETAILED DESCRIPTION

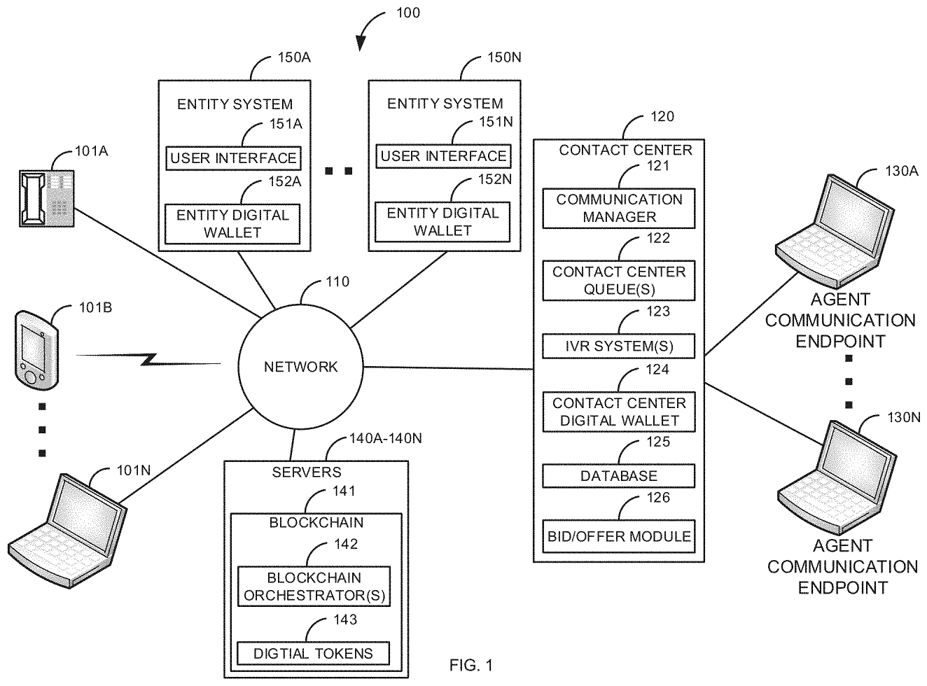

FIG. 1 is a block diagram of a first illustrative system 100 for inserting advertising into a voice and/or video stream of a communication session while the communication session is placed on hold. The first illustrative system 100 comprises customer communication endpoints 101A-101N, a network 110, a contact center 120, agent communication endpoints 130A-130N, servers 140A-140N, and entity systems 150A-150N.

The customer communication endpoints 101A-101N can be or may include any user communication endpoint device that can communicate on the network 110, such as a Personal Computer (PC), a telephone, a video system, a cellular telephone, a Personal Digital Assistant (PDA), a tablet device, a notebook device, a smartphone, a laptop computer, and/or the like. The customer communication endpoints 101A-101N are devices where a communication session terminates. The customer communication endpoints 101A-101N are not network elements that facilitate and/or relay a communication session in the network 110, such as a communication manager 121 or router. As shown in FIG. 1, any number of customer communication endpoints 101A-101N may be connected to the network 110.

The network 110 can be or may include any collection of communication equipment that can send and receive electronic communications, such as the Internet, a Wide Area Network (WAN), a Local Area Network (LAN), a Voice over IP Network (VoIP), the Public Switched Telephone Network (PSTN), a packet switched network, a circuit switched network, a cellular network, a combination of these, and/or the like. The network 110 can use a variety of electronic protocols, such as Ethernet, Internet Protocol (IP), Session Initiation Protocol (SIP), Integrated Services Digital Network (ISDN), H.323, Web Real-Time Communication (WebRTC) protocol, video protocols, email protocols, text messaging protocols, Instant Messaging (IM) protocols, and/or the like. Thus, the network 110 is an electronic communication network configured to carry messages via packets and/or circuit switched communications.

The contact center 120 can be or may include any hardware coupled with software that can route communication sessions between the customer communication endpoints 101A-101N and the agent communication terminals 130A-130N. The contact center 120 further comprises a communication manager 121, contact center queue(s) 122, Interactive Voice Response (IVR) system(s) 123, a contact center digital wallet 124, a database 125, and a bid/offer module 126.

The communication manager 121 can be or may include any hardware coupled with software that can manage and route communications in the contact center 120, such as a Private Branch Exchange (PBX), a proxy server, a session manager, an Instant Messaging (IM) server, a text messaging server, a video router, a conference bridge, and/or the like.

The contact center queue(s) 122 can be or may include any computer construct that holds a communication session until it can be processed by a contact center agent. The contact center queue(s) 122 can hold voice communication sessions, video communication sessions, IM communication sessions, text messages, emails, and/or the like. The contact center queue(s) 122 may individually support different products or services provided by the contact center 120.

The Interactive Voice Response (IVR) system(s) 123 can be or may include any hardware coupled with software that can verbally and/or visually interact with a user in a voice or video communication session. The IVR system(s) 123 typically provides a series of menus that allow a voice or video communication session (e.g., a voice call) to be routed to a specific contact center queue 122 and/or contact center agent.

The contact center digital wallet 124 tracks digital tokens 143 that are owned by the contact center 120. For example, when the contact center accepts an offer to provide advertising for an entity (e.g., a marketing campaign for a specific product), a number of digital tokens 143 are debited from an entity digital wallet 152 and a corresponding amount of digital tokens 143 are credited to the contact center digital wallet 124.

The database 125 can be or may include any type of data storage, such as, a relational database, a file system, an objected-oriented database, a directory service, and/or the like. The database 125 can be used to store one or more transaction records. A transaction record typically contains information that is associated with a transaction, such as, a recording of an advertisement, an advertising code, a customer name (a customer who is in a voice or video communication session that is placed on hold), other customer information (address, telephone number, customer demographics, etc.), dates/time of playing advertisements, a communication session identifier, a product or service name, a location of a customer, a time of the voice/video communication session, a date of the voice/video communication session, and/or the like.

In one embodiment, the database 125 may be separate from the contact center 120. For example, the database 125 may be on a secure server that is part of a centralized database 125, which includes a transaction record associated with an acceptance of an offer and/or a playing of an advertisement.

The bid/offer module 126 can be or may include any hardware/software that can manage bids/offers between the contact center 120 and the entity systems 150A-150N. The bid/offer module 126 can generate/negotiate bids/offers based on various criteria, such as, based on a predefined customer profile, administered input, and/or the like.

The servers 140A-140N comprise blockchain(s) 141. The servers 140A-140N can be or may include any servers 140 that can be used to keep a digital ledger. A digital ledger is where multiple copies of the same blockchain(s) 141 are stored on separate servers 140A-140N in order to validate a transaction. The digital ledger typically has copies of a single blockchain 141 that are used for all transactions in the contact center 120. When a new transaction occurs in the contact center 120, if the transaction is validated, a new block is added to the blockchains 141 on each of the servers 140A-140N to keep a record of the transaction. In one embodiment there may be a separate blockchain 141 associated with each entity.

The blockchains 141 further comprise blockchain orchestrator(s) 142 and digital tokens 143. The blockchain orchestrator(s) 142 are executed based on a transaction, such as, an acceptance of an offer, playing of an advertisement, and/or the like. Within the blockchain orchestrator 142 are typically one or more basic rules for determining how to debit/credit digital tokens 143 based on various types of transactions that may occur in/with the contact center 120. The blockchain orchestrator 142 is executable software that is stored with the blockchain(s) 141. There is typically one blockchain orchestrator 142 that is used by the contact center 120.

When a transaction occurs, the blockchain orchestrator 142 is executed. The blockchain orchestrator 142 software validates the transaction. If the transaction is validated, a credit/debit of the digital tokens 143 (i.e., the digital tokens 143 owned by contact center 120/entity) is added in the form of a transaction within a new block in the blockchain 141. The debit/credit is then propagated to the entity digital wallet 152/contact center digital wallet 124.

The blockchain orchestrator 142 contains a start-up function that runs only once, when the blockchain orchestrator 142 is first uploaded from the network 110. This function sets the initial balance of digital tokens 143 in the contact center digital wallet 124. The blockchain orchestrator 142 may also include a transfer function that is called in order to transfer/move digital tokens 143 from one digital wallet (152/124) to another. The transfer function may include function arguments for a recipient (e.g. a name/ID of the recipient's account) and a value (i.e. the number of tokens to transfer). A balance checking function may also be included within the blockchain orchestrator 142 to ensure that the entity has a sufficient number of digital tokens 143 prior to completing the transfer. The blockchain orchestrator 142 can be defined in such a way that negative balances are not permitted—or alternatively they can be handled as “debt”. The blockchain orchestrator 142 may also include support for event functions. The blockchain orchestrator 142 calls these event functions to ensure that progress events are shared with the entity as the blockchain orchestrator 142 executes.

The entity systems 150A-150N can be or may include any hardware coupled with software that can communicate with the contact center 120, such as, a server, a communication device, and/or the like. The entity systems 150A-150N further comprise user interfaces 151A-151N and entity digital wallets 152A-152N.

The user interfaces 151A-151N allow a user to access the digital wallets 152A-152N. The user interfaces 151A-151N may be a graphical user interface.

The entity digital wallets 152A-152N can be or may include any software application that can track the number of digital tokens 143 owned by the entity. The digital wallets 152A-152N may work with the user interfaces 151A-151N to provide a user the ability to accept an offer and negotiate how the advertisements will be provided to customers when a voice or video communication session is placed on hold in a contact center queue 122.

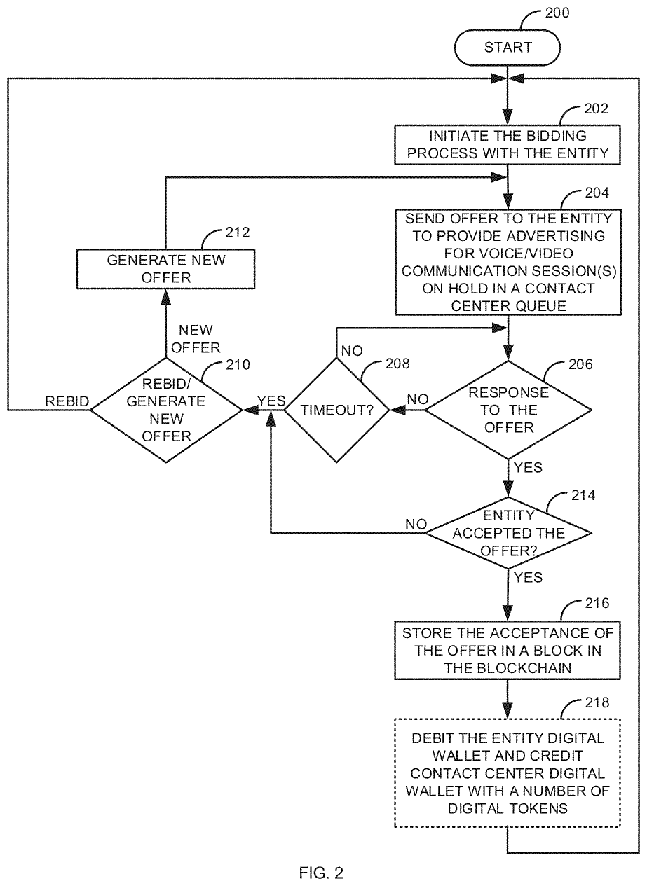

FIG. 2 is a flow diagram of a process for negotiating an offer and using a blockchain 141 to track an acceptance of the offer. Illustratively, the customer communication endpoints 101A-101N, the contact center 120, the communication manager 121, the contact center queue(s) 122, the IVR system(s) 123, the digital contact center wallet 124, the database 125, the bid/offer module 126, the agent communication endpoints 130A-130N, the servers 140A-140N, the blockchain(s) 141, the blockchain orchestrators 142, the digital tokens 143, the entity systems 150A-150N, the user interfaces 151A-151N, and the entity digital wallets 152A-152N are stored-program-controlled entities, such as a computer or microprocessor, which performs the method of FIGS. 2-5 and the processes described herein by executing program instructions stored in a computer readable storage medium, such as a memory (i.e., a computer memory, a hard disk, and/or the like). Although the methods described in FIGS. 2-5 are shown in a specific order, one skilled in the art would recognize that the steps in FIGS. 2-5 may be implemented in different orders and/or be implemented in a multi-threaded environment. Moreover, various steps may be omitted or added based on implementation.

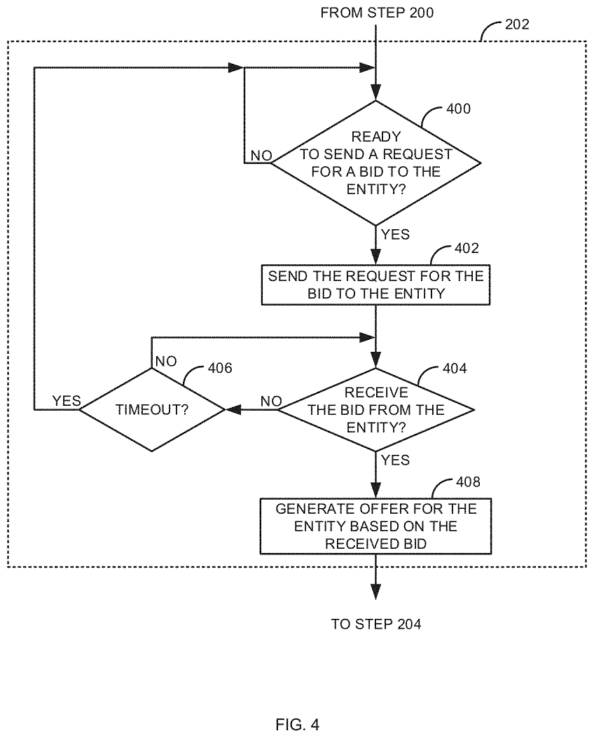

The process of FIG. 2 starts in step 200. The bid/offer module 126 initiates the bidding process in step 202. The bidding process may include the entity defining how/when it wants the advertising to be provided while customers are placed on hold in a contact center queue 122. For example, the entity may define/quantify terms, such as, the time of the advertisement (e.g., 10-12 AM), a customer profile (e.g., customers who are in the age group of 30-40 years old, have a specific income, from a specific region, and/or the like), a current inbound call volume, a percentage of customers with the customer profile interacting with the contact center 120, a type of advertising (i.e., to target a specific contact center queue 122), a number of plays of the advertising, and/or the like. In one embodiment, the bidding process of step 202 may be initiated directly from the entity. Alternatively, as described in FIG. 4, the bidding process may be initiated by the contact center 120.

As a result of the bidding process of step 202, the bid/offer module 126 sends (e.g., via the network 110), in step 204, an offer to a selected entity (or entities) to provide advertising for voice and/or video communication session(s) that are placed on hold in a contact center queue 122. The offer may include various terms, such as, a price (number of digital tokens 143), a number of plays of the advertising, specific customer types (e.g., ages 20-30), specific times that the advertising will be played, windows for playing multiple different advertisements (e.g., different advertisements are played to different groups of customers) and/or the like. The bid/offer module 126 determines, in step 206, if the entity (or entities) has responded to the offer. For example, the entity system 150A may send a response to accept the offer of step 204 based on a user accessing the user interface 151A (provided by the digital wallet 152A). Alternately, the entity system 150A may respond to the offer of step 204 automatically.

If a response to the offer is not sent in step 206, the bid/offer module 126 determines, in step 208, if a timeout has occurred. The timeout may be time based or event based. For example, if a specific number of entities have already accepted the offer (i.e., the offer is based on first come first serve basis) for which the given time slot of the offer becomes full, the remaining outstanding offers then become invalid. If a timeout has not occurred in step 208, the process goes back to step 206. Otherwise, if the timeout has occurred in step 208, the bid/offer module 126 determines, in step 210, whether to rebid the advertising (e.g., bid it out to a different entity (or entities)) or to generate a new offer for the same entity (or entities). The decision of step 210 may be based on various factors, such as, how much advertising time is available, a previous history from the bidding process, and/or the like. The bid/offer module 126 may decide to generate a new offer based on a relationship between the contact center 120 and the entity. For example, the entity may be a child organization of a corporation that owns the contact center 120 or the contact center 120 may be part of a parent organization where the entity is owned by the parent organization.

If the bid/offer module 126 determines, in step 210, to generate anew offer, the bid/offer module 126 generates a new offer in step 212. For example, the bid/offer module 126 may lower the price (the number of digital tokens 143), change the hours of when the advertising is played, change the demographics, and/or the like for the new offer generated in step 212. The process then goes back to step 204 where the offer is sent to the entity. Otherwise, if the bid/offer module 126 determines, in step 210, to rebid the advertising, the process goes back to step 202.

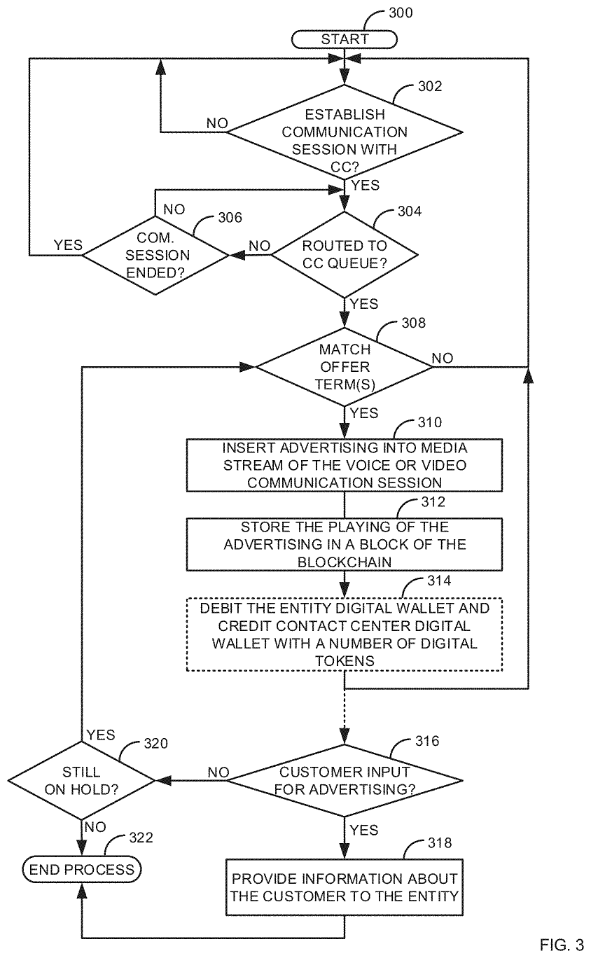

If the entity responds to the offer in step 206, the bid/offer module 126 determines if the offer was accepted in step 214. If the offer was not accepted in step 214, the process goes to step 210. Otherwise, if the offer was accepted in step 214, the blockchain orchestrator 142 stores, in step 216, the acceptance of the offer in a block in the blockchain 141. In one embodiment, the blockchain orchestrator 142 stores credit/debit information for the transaction (acceptance of the offer) in the block. In this embodiment, a single transaction is stored (when the offer is accepted versus a per play of the advertising as discussed in FIG. 3). For example, the blockchain orchestrator 142 records the transaction along with the number of digital tokens 143 that were credited to the contact center digital wallet 124 and debited from the entity digital wallet 152 based on the price defined in the offer. The stored block may contain other information, such as, the time/date of the acceptance of offer and the parties involved in accepting the offer and/or any type of information associated with the offer. In addition, a pointer that points to a transaction record in the database 125 may be stored in the block. The transaction record may contain information, such as, recording(s) of advertisements, an advertisement code, an address of the contact center 120/entity, a name/identity of a person in the entity who accepted the offer, and/or the like. The pointer to the transaction record may be used to ensure privacy for the participants. By storing private information in the transaction record versus the blockchain 141, specific private information can be securely maintained external to the blockchain 141.

If the acceptance of the offer causes an exchange of digital tokens 143, the blockchain orchestrator 142 debits, in step 218, from the entity digital wallet 152, the number of digital tokens 143 defined in the offer and credits the contact center digital wallet 124 with the same number of digital tokens 143. The process then goes to step 202.

FIG. 3 is a flow diagram of a process for inserting advertising into a voice and/or video stream of a voice or video communication session according to terms of an offer while the communication session is placed on hold in a contact center queue 122. The process starts in step 300. The communication manager 121 determines, in step 302, if a voice or video communication session has been established with the contact center 120. For example, a customer, at the customer communication endpoint 101A, has called a 1-800 number of the contact center 120 and has been connected to the IVR system 123. If a voice or video communication session has not been established in step 302, the process of step 302 repeats.

Otherwise, if a voice or video communication session has been established in step 302 (e.g., a thread is spun off when a communication is established), the communication manager 121 determines, in step 304, if the voice or video communication session has been routed to a contact center queue 122. For example, the voice or video communication session may be routed by the communication manager 121 to the contact center queue 122 based on user input to the IVR system 123. If the voice or video communication session has not been routed to the contact center queue 122 in step 304, the communication manager 121 determines, in step 306, if the voice or video communication session has ended. If the voice or video communication session has ended in step 306, the process goes back to step 302. Otherwise, if the voice or video communication session has not ended in step 306, the process goes back to step 304.

If the voice or video communication session has been routed to a contact center queue 122 in step 304, the bid/offer module 126 determines if the voice or video communication session matches the agreed upon terms of the accepted offer (of step 214). For example, if the terms of the accepted offer require the advertising to be provided from 1:00 P.M. to 4:00 P.M on Monday-Friday to customers who are of the age of 20-40, the bid/offer module 126 determines if the voice or video communication session matches this criteria. If the voice or video communication session does not match the terms of the offer in step 308 (e.g., the customer in the voice or video communication session is 60 years old), the process goes to step 302 and proceeds as a normal voice or video communication session with the default on hold behavior of the contact center 120.

Otherwise, if the voice or video communication session matches the terms of the offer in step 308, the bid/offer module 126 inserts, in step 310, the advertising into the media stream of the voice or video communication session. For example, the advertising may be a video advertisement that describes a particular product that is played to the customer while the customer is on hold in the contact center queue 122. The inserted advertising may be other types of information, such as, the entity's Twitter® feed or Facebook® page. The advertising may be inserted into the voice or video communication session in various ways, such as, by inserting a Session Initiation Protocol (SIP) Back-To-Back User Agent (B2BUA) into a SIP voice/video communication session, by the IVR system 123 playing the advertising, and/or the like.

The playing of the advertising (a transaction) is stored, in step 312, by the blockchain orchestrator 142 in the blockchain 141. In one embodiment, the blockchain orchestrator 142 debits, in step 314, the entity digital wallet 152 and credits the contact center digital wallet 124 a corresponding number of digital tokens 143. Step 314 is an optional step that works where the bid/offer module 126 does the debiting/crediting on a per-play of the advertising versus a one-time debit/credit based on acceptance of the offer as described in step 218. In one embodiment the debiting/crediting of steps 218/314 may both occur. For example, there may be an initial exchange of digital tokens 143 when the entity accepts the offer and then an exchange of digital tokens 143 each time an advertisement is individually played to a customer. The process then goes back to step 302.

In one embodiment, the IVR system 123 may manage input from a customer in regard to the advertising. The process of managing input from the customer may be managed in a separate thread/process. For example, the IVR system 123 may spin of a thread/process for each voice/video communication session where an advertisement is being played. In this embodiment, there may be multiple threads running concurrently for each audio/video communication session that is on hold in the contact center queue 122 where an advertisement is being played. The IVR system 123 determines, in step 316, if the customer has provided input for the advertising. For example, the IVR system 123 may play a message stating that the customer can enter a number (e.g., the number 5) to receive a callback regarding the advertising. The message provided by the IVR system 123 may provide various options, such as, to be called back after the voice or video communication session has ended, at a defined time, and/or the like.

If the customer has not provided a response to the advertising in step 316, the IVR system determines, in step 320, if the voice or video communication session is still on hold. For example, the voice or video communication session may have been transferred from the contact center queue 122 to an agent communication endpoint 130. If the voice or video communication session is still on hold in step 320, the process goes back to step 308. Otherwise, if the voice or video communication session is no longer on hold in step 320, the process ends in step 322.

If input has been provided by the customer in step 316, the bid/offer module 126 provides, in step 318, information about the customer to the entity. For example, the bid/offer module 126 may provide a telephone number, the customer's name, contact information, email addresses (i.e., a customer profile), when the customer wants called, and/or the like so that the entity may contact the customer in regard to the advertising. The process then ends in step 322.

FIG. 4 is a flow diagram of a process for managing a bidding process in a contact center 120. FIG. 4 is an exemplary embodiment of step 202 of FIG. 2. After starting in step 200, the bid/offer module 126, determines, in step 400, if it is ready to send a bid to the entity (or entities). If the bid/offer module 126 determines, in step 400, that it is not ready to send a bid in step 400, the process of step 400 repeats. The bid/offer module 126 may determine that it is ready to make a bid based on various factors, such as, a call volume at the contact center 120, a percentage of customers with a specific customer profile (e.g., under the age of 40), and/or the like.

If the bid/offer module 126 is ready to send a bid in step 400, the bid/offer module 126 sends, in step 402, the request for a bid to the entity. The request for a bid may contain various parameters that define how the advertising is to be delivered, such as, time periods that are currently available, specific customer demographics that are available, a number of customers for the advertising, and/or the like. A bidding algorithm is used to define the parameters. The bidding parameters may be administrated by an administrator of the contact center 120. In addition, the bidding algorithm may be able to automatically alter/regenerate bids in real-time. For example, the bid price may be altered/regenerated when the call volume is higher versus when the call volume is lower. The bidding algorithm may use other factors to restrict who can make a bid. For example, competitors of the contact center 120 may be restricted from bidding or receiving bid requests.

The bid/offer module 126 determines, in step 404, if a bid has been received from the entity. If a bid has not been received from the entity in step 404, the bid/offer module 126 determines, in step 406, if a timeout has occurred. For example, the request for a bid may have a 5 minute expiration period. If a timeout has occurred in step 406, the process goes back to step 400.

Otherwise, if a timeout has not occurred in step 406, the process goes back to step 404 to wait to receive a bid. If a bid has been received in step 404, the bid/offer module 126 generates, in step 408, an offer based on the received bid. For example, the offer may define a price (a number of digital tokens 143), a number of plays of the advertising, time periods, demographics, and/or the like. The bid/offer module 126 may use an internal algorithm to arrive at the defined price based on the received bid. The process then goes to step 204 where the offer is sent to the entity.

While the process of FIG. 4 is described where a single bid is outstanding, the processes described herein can send out multiple bids at the same time. For example, the bid/offer module 126 may send out multiple requests for bids in parallel and wait for one (or any number) of the responses to be received. Once received, the bid/offer module 126 may generate a single offer based on the best match of the received bids. This may be accomplished based on the best match with the current contact center 120 statistics. Alternatively, the bids may be sent in a serial manner until one of the entities accepts the offer. The above processes are described where the contact center 120 and the entities understand the same digital tokens 143. However, in cases where the digital tokens 143 are not the same, a form of digital token 143 exchange may be used so that transactions can be completed.

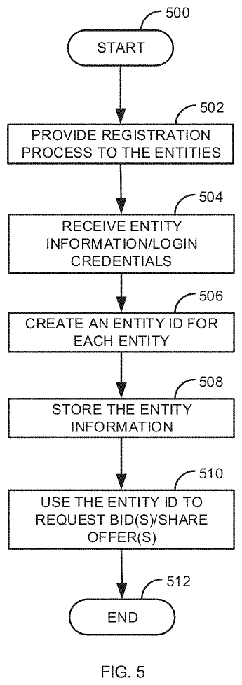

FIG. 5 is a flow diagram of a process for registering entities with the contact center 120. The process starts in step 500. The bid/offer module 126 provides, in step 502, a registration process to the entities. For example, the registration process may be provided via web page, via a mobile application, and/or the like. The entity (i.e., a user) provides information associated with the entity, such as the entity name, address, and/or the like. In addition, the entity typically provides some type of login credentials, such as, user name, a password, a biometric, and/or the like. The bid/offer module 126 receives the entity information/login credentials in step 504.

The bid/offer module 126 creates an entity identifier for each entity that registers in step 506. The bid/offer module 126 stores the entity information/entity identifiers in step 508. The bid/offer module 126 uses the entity identifiers to request bids and to share offers. For example, in one embodiment, a common entity digital wallet 152 may be used for the entities. For example, the contact center 120 may be a parent organization where the common entity digital wallet 152 is employed to be used by multiple child organizations. In this embodiment, each child organization can register with the common entity digital wallet 152 to create separate accounts using the registered entity IDs. The child organizations can then purchase offers from each other. If a child organization purchases an offer, this transaction is recorded in the blockchain 141.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core®i5-4670K and i7-4770K 22 nm Haswell, Intel® Core®i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those skilled in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A contact center comprising:
a microprocessor; and
a computer readable medium, coupled with the microprocessor and comprising microprocessor readable and executable instructions that, when executed by the microprocessor, cause the microprocessor to:
send, via a network, a first offer to a first entity system, wherein the first offer is to provide advertising while one or more voice or video communication sessions are placed on hold in a contact center queue;
receive, via the network, an acceptance of the first offer from the first entity system, wherein the acceptance of the first offer causes a blockchain orchestrator to create a block that is stored in a blockchain;
establish, at the contact center, a first voice or video communication session with a first customer;
route the first voice or video communication session to the contact center queue;
in response to routing the first voice or video communication session to the contact center queue and based on the acceptance of the first offer, insert the advertising into a media stream of the voice or video communication session; and
before sending the first offer to the first entity system, send, via the network, a request for a bid to the first entity system, wherein the request for the bid is sent based on multiple customers with a specific customer profile interacting with the contact center.

2. The system of claim 1, wherein the microprocessor readable and executable instructions further cause the microprocessor to:
send, via the network, the request for the bid comprising one or more parameters that define how the advertising is to be delivered;
receive, via the network, the bid, wherein the bid defines how the advertising is to be delivered; and
generate the first offer based on the bid.

3. The system of claim 1, wherein the request for the bid is also sent based on a current inbound call volume.

4. The system of claim 1, wherein in response to the first block being stored in the blockchain, debiting an entity digital wallet with a number of digital tokens and crediting a contact center digital wallet with the number of digital tokens.

5. The system of claim 4, wherein the entity digital wallet is a digital wallet for a plurality of entities.

6. The system of claim 1, wherein the block comprises a pointer to a transaction record, wherein the transaction record comprises at least one of: a recording of the advertising and a code associated with the advertising.

7. The system of claim 1, wherein the microprocessor readable and executable instructions further cause the microprocessor to:
receive, via an Interactive Voice Response (IVR) system, while the first voice or video communication session is on hold, input from the first customer, wherein the input from the first customer indicates that the first customer wants a callback based on the inserted advertising.

8. The system of claim 7, wherein the contact center provides information about the first customer in real-time to the first entity system.

9. The system of claim 1, wherein the microprocessor readable and executable instructions further cause the microprocessor to:
send, via the network, a second offer to a second entity system, wherein the second offer is sent prior to the first offer;
receive, via the network, a rejection of the second offer from the second entity system; and
in response to receiving the rejection of the second offer from the second entity system, send the first offer to the first entity system.

10. The system of claim 1, wherein the microprocessor readable and executable instructions further cause the microprocessor to:
send, via the network, a second offer to the first entity system, wherein the second offer is sent prior to the first offer;
receiving, via the network, a rejection of the second offer from the first entity system; and
in response to receiving the rejection of the second offer from the first entity system, generate the first offer, wherein the first offer is based on a recalculation of the second offer using additional contact center information.

11. The system of claim 1, wherein the advertising comprises a plurality of advertisements, wherein the plurality of advertisements are played to a plurality of different customers based on a plurality of customer defined profiles in the first offer.

12. A method comprising:
sending, by a microprocessor via a network, a first offer to a first entity system, wherein the first offer is to provide advertising while one or more voice or video communication sessions are placed on hold in a contact center queue;
receiving, by the microprocessor via the network, an acceptance of the first offer from the first entity system, wherein the acceptance of the first offer causes a blockchain orchestrator to create a block that is stored in a blockchain;
establishing, by the microprocessor, a first voice or video communication session with a first customer;
routing, by the microprocessor, the first voice or video communication session to the contact center queue;
in response to routing the first voice or video communication session to the contact center queue and based on the acceptance of the first offer, inserting, by the microprocessor, the advertising into a media stream of the voice or video communication session; and
before sending the first offer to the first entity system, sending, by the microprocessor via the network, a request for a bid to the first entity system, wherein the request for the bid is sent based on multiple customers with a specific customer profile interacting with the contact center.

13. The method of claim 12, further comprising:
sending, by the microprocessor via the network, the request for the bid comprising one or more parameters that define how the advertising is to be delivered;
receiving, by the microprocessor via the network, the bid, wherein the bid defines how the advertising is to be delivered; and
generating, by the microprocessor, the first offer based on the bid.

14. The method of claim 12, wherein the request for the bid is also sent based on a current inbound call volume.

15. The method of claim 12, wherein in response to the first block being stored in the blockchain, debiting an entity digital wallet with a number of digital tokens and crediting a contact center digital wallet with the number of digital tokens.

16. The method of claim 14, wherein the entity digital wallet is a digital wallet for a plurality of entities.

17. The method of claim 12, further comprising:
receiving, via an Interactive Voice Response (IVR) system, while the first voice or video communication session is on hold, input from the first customer, wherein the input from the first customer indicates that the first customer wants a callback based on the inserted advertising.

18. The method of claim 12, further comprising:
sending, via the network, a second offer to a second entity system, wherein the second offer is sent prior to the first offer;
receiving, via the network, a rejection of the second offer from the second entity system; and
in response to receiving the rejection of the second offer from the second entity system, sending the first offer to the first entity system.

19. The method of claim 12, further comprising:
sending, via the network, a second offer to the first entity system, wherein the second offer is sent prior to the first offer;
receiving, via the network, a rejection of the second offer from the first entity system; and
in response to receiving the rejection of the second offer from the first entity system, generating the first offer, wherein the first offer is based on a recalculation of the second offer using additional contact center information.

20. A contact center comprising:
a microprocessor; and
a computer readable medium, coupled with the microprocessor and comprising microprocessor readable and executable instructions that, when executed by the microprocessor, cause the microprocessor to:
send, via a network, a first offer to a first entity system, wherein the first offer is to provide advertising while one or more voice or video communication sessions are placed on hold in a contact center queue;
receive, via the network, an acceptance of the first offer from the first entity system;
establish, at the contact center, a first voice or video communication session with a first customer;
route the first voice or video communication session to the contact center queue;
in response to routing the first voice or video communication session to the contact center queue and based on the acceptance of the first offer, insert the advertising into a media stream of the voice or video communication session, wherein inserting the advertising into the media stream causes a blockchain orchestrator to create a block that is stored in a blockchain; and
before sending the first offer to the first entity system, send, via the network, a request for a bid to the first entity system, wherein the request for the bid is sent based on multiple customers with a specific customer profile interacting with the contact center.
